(19) United States
(12) Patent Application Publication
(10) Pub. No.: US 2018/0198170 A1
(43) Pub. Date: Jul. 12, 2018

(54) ALL-SOLID-STATE LITHIUM BATTERY

(71) Applicant: NGK INSULATORS, LTD., Nagoya-Shi (JP)

(72) Inventors: Yuki FUJITA, Nagoya-Shi (JP); Nobuyuki KOBAYASHI, Nagoya-Shi (JP)

(73) Assignee: NGK INSULATORS, LTD., Nagoya-Shi (JP)

(21) Appl. No.: 15/910,329

(22) Filed: Mar. 2, 2018

Related U.S. Application Data
(63) Continuation of application No. PCT/JP2016/079295, filed on Oct. 3, 2016.

(30) Foreign Application Priority Data
Oct. 15, 2015 (JP) 2015-203512
Jan. 8, 2016 (JP) 2016-002848
Mar. 16, 2016 (JP) 2016-052119
Apr. 22, 2016 (JP) 2016-086518

(51) Int. Cl. H01M 10/0585; H01M 10/052; H01M 4/525; H01M 4/66; H01M 4/38; H01M 10/0562

(52) U.S. Cl. CPC H01M 10/0585; H01M 10/052; H01M 4/525; H01M 4/667; H01M 2004/028; H01M 10/0562; H01M 4/663; H01M 4/661; H01M 4/382

(57) ABSTRACT

Provided is an all-solid-state lithium battery capable of significantly reducing an increase in resistance during repeated use and thereby considerably improving the long-term reliability despite the use of a thick positive electrode plate composed of a sintered body. The all-solid-state lithium battery includes a self-supporting positive electrode plate composed of a sintered body containing a plurality of crystal grains composed of a positive-electrode active material and having a thickness of 20 μm or more, a solid electrolyte layer composed of a lithium-ion conductive material disposed on the positive electrode plate, a lithium-containing negative electrode layer disposed on the solid electrolyte layer, and a positive electrode current collector composed of metal foil having a thickness of from 5 μm to 30 μm, the positive electrode current collector being in unbound contact with the entire surface of a second side of the positive electrode plate remote from the solid electrolyte layer.

### CROSS-REFERENCE TO RELATED APPLICATIONS

This application is a continuation application of PCT/JP2016/079295 filed Oct. 3, 2016, which claims priority to Japanese Patent Application No. 2015-203512 filed Oct. 15, 2015, Japanese Patent Application No. 2016-002848 filed Jan. 8, 2016, Japanese Patent Application No. 2016-052119 filed Mar. 16, 2016, and Japanese Patent Application No. 2016-086518 filed Apr. 22, 2016, the entire contents all of which are incorporated herein by reference.

### BACKGROUND OF THE INVENTION

### 1. Field of the Invention

The present invention relates to all-solid-state lithium batteries.

### 2. Description of the Related Art

Productions of batteries including ceramic sintered body as positive electrodes have been attempted. For example, Patent Document 1 (JP3427570B) discloses a nonaqueous electrolyte secondary battery including a negative electrode made of a carbonaceous material, lithium metal, or lithium alloy, a positive electrode made of a lithium complex oxide sintered body, and nonaqueous electrolyte. Patent Document 2 (JP5775444B) discloses an electrode for nonaqueous electrolyte battery, the electrode including a sheet-like conductive core material, a carbon layer, an active material layer, and a coating layer; and the active material layer including a ceramic film composed of a sintered body of a transition metal oxide that can occlude and/or release lithium and having a thickness of 20 to 120 μm.

Incidentally, in traditional batteries used in portable devices, such as personal computers and cellular phones, liquid electrolytes (electrolytic solutions) of lithium salts dissolved in flammable organic solvents are used as media for ion transfer media. The battery containing such an electrolytic solution has a risk of the leakage of the electrolytic solution, ignition, explosion, or the like. To solve the problems, an all-solid-state lithium battery has been developed that contains a solid electrolyte instead of a liquid electrolyte and consists of only solid components for ensuring the intrinsic safety. The all-solid-state lithium battery, which contains a solid electrolyte, has a low risk of ignition, causes no liquid leakage, and barely causes a decline in the battery performance due to corrosion. For example, Patent Document 3 (JP2013-105708A) discloses a thin-film lithium secondary battery including a positive electrode layer made of lithium cobaltate (LiCoO₂), a negative electrode layer made of metallic lithium, and a solid electrolyte layer that can be formed of a lithium phosphate oxynitride (LiPON) glass electrolyte, and describes that the positive electrode layer is formed by sputtering and has a thickness within a range of 1 to 15 μm. In this document, the thin-film lithium secondary battery is produced by forming a positive electrode layer composed of lithium cobaltate on a substrate, forming a solid electrolyte layer on the positive electrode layer, and forming a negative electrode layer composed of metallic lithium on the solid electrolyte layer.

### CITATION LIST

### Patent Documents

Patent Document 1: JP3427570B

Patent Document 2: JP5775444B

Patent Document 3: JP2013-105708A

### SUMMARY OF THE INVENTION

Incidentally, a positive electrode plate made of a ceramic sintered body undergoes a variation in dimensions by the intercalation and deintercalation of Li ions accompanied with charge and discharge. It is therefore demanded to evenly charge and discharge the entire positive electrode plate for reducing occurrence of stress due to uneven dimensional change. In particular, in an all-solid-state lithium battery, the transfer of Li ions in the solid electrolyte in a direction parallel to the plate face cannot be expected. Accordingly, if the charge and discharge of the positive electrode plate are uneven in the plane, the charge and discharge on the negative electrode side is also uneven like the positive electrode, resulting in a decline in the charge and discharge performance. In contrast, in a liquid-system battery using an electrolytic solution, the concentration diffusion of Li ions in the electrolytic solution occurs in all directions. Accordingly, the uneven concentration of Li ions possibly occurring on the positive electrode plate surface can readily disappear, and the negative electrode can be uniformly charged or discharged. This is caused especially by transfer of Li ions in the direction parallel to the plate face in the electrolytic solution on the positive electrode plate surface. Accordingly, in an all-solid-state battery, in order to enable even charge and discharge of the positive electrode plate in the plate face direction, it is proposed to evenly form a current collecting layer composed of an electrically conductive agent having a sufficiently low resistance in the in-plane direction on the back surface of the positive electrode plate. In a positive electrode plate designed so as to have a high density, a large thickness, and a high energy density, for example, a specific structure is needed, such as formation of a metal film having a thickness of 10 μm or more on the surface of the positive electrode plate by, for example, baking, or binding of metal foil (current collecting foil) having a thickness of 5 μm or more to the surface of the positive electrode plate with an electrically conductive adhesive. In both structures, the positive electrode plate expands and contracts by charge and discharge to cause an increase in contact resistance by deterioration factors, such as interfacial separation, during the use with a deep charge/discharge depth or the use for a long period of time, resulting in low reliability. Thus, a positive electrode plate composed of a dense and thick ceramic sintered body used in the positive electrode of an all-solid-state lithium battery requires further improvements in long-term reliability.

The present inventors have found that in an all-solid-state lithium battery including a thick positive electrode plate composed of a sintered body, an increase in resistance during repeated use can be significantly reduced by bringing the positive electrode plate into entire contact with a thin positive electrode current collector in an unbonded state with no adhesive, and the long-term reliability consequently can be considerably improved.

Accordingly, it is an object of the present invention to provide an all-solid-state lithium battery capable of significantly reducing an increase in resistance during repeated use and thereby considerably improving the long-term reliability despite the use of a thick positive electrode plate composed of a sintered body.

An embodiment of the present invention provides an all-solid-state lithium battery comprising:
a self-supporting positive electrode plate comprising a sintered body containing a plurality of crystal grains composed of a positive-electrode active material, the positive electrode plate having a thickness of 20 μm or more;
a solid electrolyte layer composed of a lithium-ion conductive material disposed on
a first side of the positive electrode plate;
a lithium-containing negative electrode layer disposed on the solid electrolyte layer; and
a positive electrode current collector composed of metal foil having a thickness of 5 μm or more and 30 μm or less, the positive electrode current collector being in unbound contact with the entire surface of a second side of the positive electrode plate remote from the solid electrolyte layer, the unbound contact being free from an adhesive.

### BRIEF DESCRIPTION OF THE DRAWINGS

FIG. 1 is a schematic cross-sectional view illustrating an example of the all-solid-state lithium battery of the present invention.

FIG. 2 is a schematic top view of the all-solid-state lithium battery illustrated in FIG. 1.

FIG. 3 is a schematic cross-sectional view illustrating another example all-solid-state lithium battery of the present invention.

FIG. 4 is a schematic cross-sectional view illustrating another example all-solid-state lithium battery of the present invention.

### DESCRIPTION OF EMBODIMENTS

### All-solid-state lithium battery

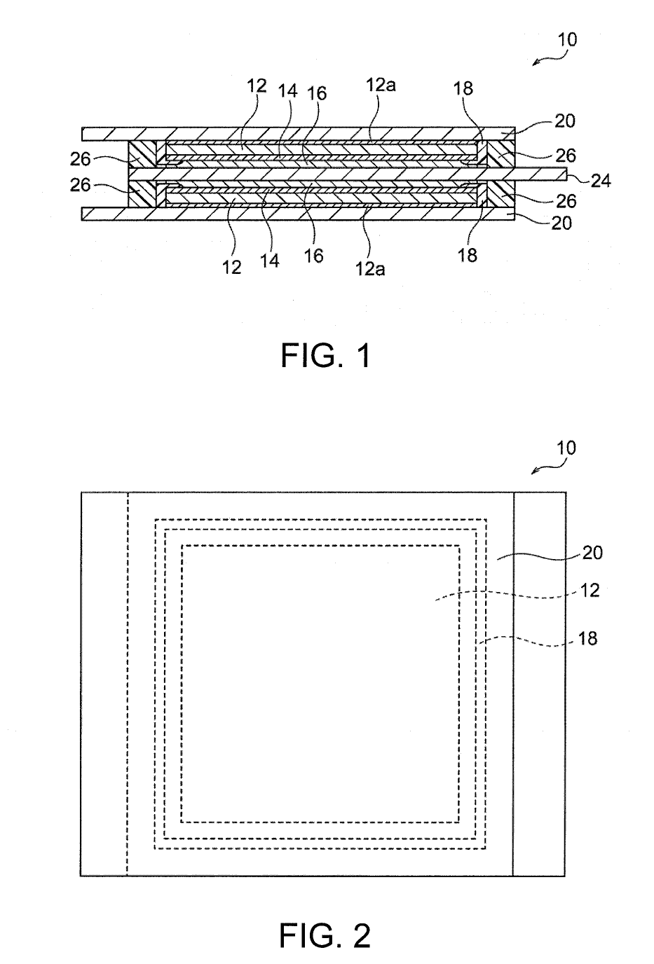

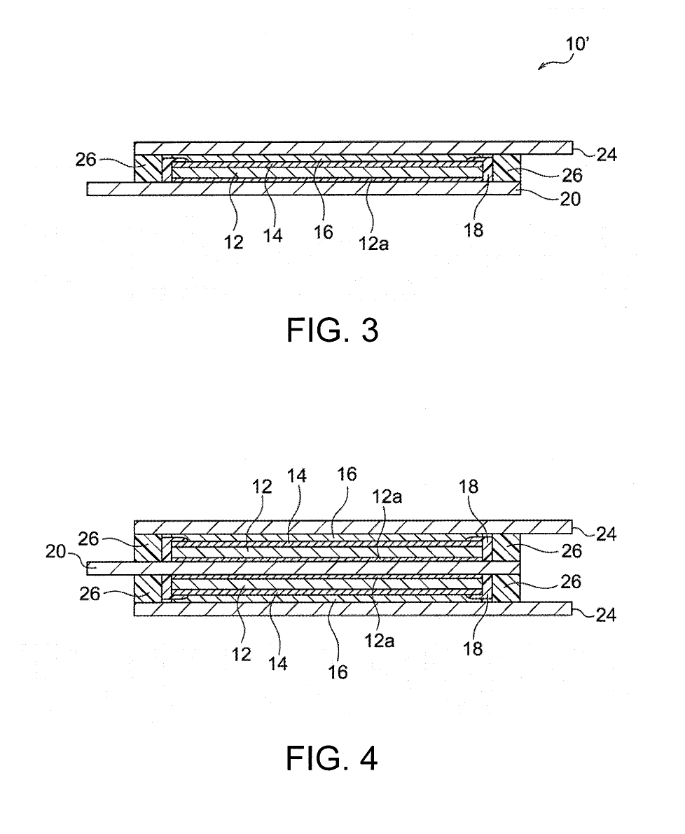

FIGS. 1 and 2 schematically illustrate an example of the all-solid-state lithium battery according to the present invention. The all-solid-state lithium battery 10 illustrated in FIGS. 1 and 2 includes a positive electrode plate 12, a solid electrolyte layer 14, a negative electrode layer 16, and a positive electrode current collector 20. The all-solid-state lithium battery 10 illustrated in FIG. 1 includes two unit cells each including a positive electrode plate 12, a solid electrolyte layer 14, a negative electrode layer 16, and a positive electrode current collector 20. The unit cells are stacked so as to have a horizontal line symmetry about a negative electrode current collector 24 disposed between the unit cells. The all-solid-state lithium battery may be composed of a single unit cell 10′ as schematically illustrated in FIG. 3 or composed of two or more unit cells connected in parallel or in series. The positive electrode plate 12 is a self-supporting plate composed of a sintered body containing a plurality of crystal grains composed of a positive-electrode active material and having a thickness of 20 μm or more. The solid electrolyte layer 14 composed of a lithium-ion conductive material is disposed on a first side of the positive electrode plate 12. The negative electrode layer 16 containing lithium is disposed on the solid electrolyte layer 14. The positive electrode current collector 20 is metal foil having a thickness of 5 μm or more and 30 μm or less and is in unbound contact with the entire second side of the positive electrode plate 12, where the unbound contact is free from an adhesive and the second side is remote from the solid electrolyte layer 14. In such an all-solid-state lithium battery including a thick positive electrode plate composed of a sintered body, an increase in resistance during repeated use can be significantly avoided by the entire contact of the positive electrode plate with the thin positive electrode current collector in an adhesive-free unbonded state, and the long-term reliability can be considerably improved. In other words, the positive electrode current collector 20 is metal foil having a thickness of 5 μm or more and 30 μm less and is a thin flexible electrically conductive material; hence, the positive electrode current collector 20 can evenly come into close contact with the entire surface of the positive electrode plate 12. However, in the positive electrode current collector 20 of metal foil in microscopically point contact with the positive electrode plate 12, uneven current collection may occur in the surface. Since the distance between contact points is significantly small compared to the thickness (20 μm or more) of the positive electrode plate 12, the uneven current collection due to positional displacement from the contact points can be cancelled by the diffusion of Li ions in the thickness direction of the positive electrode plate 12, and charge and discharge unevenness in the plate face can be eliminated. In addition, current collection is performed by the current collector 20 in unbound contact with the positive electrode plate 12 free from an adhesive; hence, the positive electrode current collector 20 basically does not follow the expansion and contraction of the positive electrode plate 12. Even if the positive electrode current collector 20 follows the expansion and contraction of the positive electrode plate 12, the metal foil as the positive electrode current collector 20 can follow the expansion and contraction to some extent due to the ductility of itself. Accordingly, the positive electrode plate 12 can move relatively with respect to the positive electrode current collector 20 according to expansion and contraction, while securing the contact with the positive electrode current collector 20. Consequently, no interfacial stress occurs between the positive electrode plate 12 and the positive electrode current collector 20, and deterioration factors, such as interfacial separation, can be precluded. As a result, the long-term reliability is thus considerably improved. That is, the interfacial separation and a consequently occurring increase in contact resistance caused by expansion and contraction during charge and discharge of the positive electrode plate 12 can be significantly reduced to improve the long-term reliability.

### Positive Electrode Current Collector

The positive electrode current collector 20 is metal foil. The metal foil has a thickness of 5 to 30 μm, preferably 5 to 25 μm, more preferably 10 to 25 μm, and further preferably 10 to 20 μm. Such a large thickness can secure a sufficient current collection function. The positive electrode current collector 20 is in unbonded contact with the entire second side of the positive electrode plate 12 away from the solid electrolyte layer 14, the unbonded contact being free from an adhesive. Accordingly, the above-mentioned extremely thin metal foil is flexible and can easily come into close contact with the entire surface of the positive electrode plate 12. The metal constituting the positive electrode current collector 20 may be any metal or alloy that does not react with the positive electrode plate 12. Preferred examples of the metal include stainless steel, aluminum, copper, platinum, and nickel, and more preferred examples are stainless steel and nickel.

The positive electrode current collector 20 preferably also serves as a positive electrode cladding covering the outside of the positive electrode plate 12. For example, as illustrated in FIG. 1, the all-solid-state lithium battery 10 may include two unit cells stacked so as to have horizontal line symmetry about a single negative electrode current collector 24 disposed between the unit cells to expose the positive electrode current collector 20 to the outside of the all-solid-state lithium battery 10. In such a battery composed of cells stacked in parallel, the negative electrode current collector 24 can function as a current collector common to the two adjoining unit cells.

The positive electrode current collector 20 is preferably pressed against the positive electrode plate 12. Since the metal foil as the positive electrode current collector 20 is a thin flexible electrically conductive material, a large number of contact points can be ensured between the positive electrode current collector 20 and the positive electrode plate 12 by the pressing force, and the positive electrode current collector 20 can more evenly come into contact with the entire surface of the positive electrode plate 12. This makes it possible to achieve a desired current collecting effect in spite of the adhesive-free unbonded state of the positive electrode current collector 20. The pressing may be performed by any method, for example, a method of pressing a flexible presser (e.g., porosity metal) that does not damage the positive electrode current collector 20 toward the positive electrode plate 12 from the outside of the positive electrode current collector 20 or a method of using a difference in pressure between the inside and outside of the positive electrode current collector 20. In particular, the pressing force of the positive electrode current collector 20 against the positive electrode plate 12 is preferably generated by the difference in pressure between the inside and outside of the positive electrode current collector 20. In detail, the positive electrode current collector 20 is under reduced pressure on the positive electrode plate 12, or the positive electrode current collector 20 is pressurized on the side opposite to the positive electrode plate 12. Since the metal foil as the positive electrode current collector 20 is a thin flexible electrically conductive material, the pressing force due to the difference in pressure between the inside and outside of the positive electrode current collector 20 allows the positive electrode current collector 20 to come into close contact with the surface of the positive electrode plate 12 at a further large number of contact points to further enhance the current collecting effect.

In a particularly preferred embodiment of the present invention, a stack including a positive electrode plate 12, a solid electrolyte layer 14, and a negative electrode layer 16 is packaged or sealed with a cladding. In this embodiment, the positive electrode current collector 20 preferably constitutes a part of the cladding, and the accommodation space of the stack packaged or sealed with such a cladding is preferably under reduced pressure. The pressure in the accommodation space can be reduced by, for example, performing packaging or sealing with a cladding under reduced pressure or degassing the accommodation space after packaging or sealing with a cladding. As described above, the metal foil as the positive electrode current collector 20 is a thin flexible electrically conductive material; hence, the positive electrode current collector 20 can come into close contact with the surface of the positive electrode plate 12 at a further large number of contact points under the reduced pressure in the accommodation space. In addition, airtight packaging or sealing with a cladding can maintain the reduced pressure in the accommodation space of the stack for a long period of time to exhibit close contact and a high current collecting effect for a long period of time. The degree of reduction in pressure may be appropriately adjusted based on the flexibility of the metal, the strength of the stack, for example.

The positive electrode current collector 20 may include an optional carbon film on the surface adjacent to the solid electrolyte layer 14. Such a configuration can enhance the electron conductivity between the positive electrode current collector 20 and the positive electrode plate 12 and can further decrease the contact resistance at the interface. The thickness of the carbon film is preferably 0.01 μm or more and 5 μm or less, more preferably 0.01 μm or more and 1 μm or less, and further preferably 0.05 μm or more and 0.5 μm or less.

### Positive Electrode Plate

The positive electrode plate 12 is a self-supporting plate composed of a sintered body containing a plurality of crystal grains composed of a positive-electrode active material and having a thickness of 20 μm or more. The crystal grains may be composed of any positive-electrode active material that can be applied to an all-solid-state lithium battery. A preferred positive-electrode active material is a lithium complex oxide. The lithium complex oxide is represented by LiₓMO₂ (0.05<x<1.10, M denotes at least one transition metal and typically includes one or more metals selected from Co, Ni, and Mn). The lithium complex oxide typically has a layered rock-salt structure. The layered rock-salt structure is a crystal structure including lithium layers and layers of a transition metal other than lithium alternately stacked with oxygen layers disposed therebetween, i.e., a crystal structure including transition metal ion layers and lithium-alone layers alternately stacked with oxide ions disposed therebetween (typically an α-NaFeO₂ structure, i.e., a structure composed of a transition metal and lithium are regularly arrayed in the [111] axis direction of a cubic rock-salt structure). Examples of the lithium complex oxide include lithium cobaltate, lithium nickelate, lithium manganate, lithium nickel manganate, lithium nickel cobaltate, lithium cobalt nickel manganate, and lithium cobalt manganate. The lithium complex oxide may contain one or more elements selected from, for example, Mg, Al, Si, Ca, Ti, V, Cr, Fe, Cu, Zn, Ga, Ge, Sr, Y, Zr, Nb, Mo, Ag, Sn, Sb, Te, Ba, Bi, and W. A particularly preferred lithium complex oxide is lithium cobaltate. In detail, particularly preferred crystal grains are lithium cobaltate crystal grains.

The positive electrode plate 12 is preferably an oriented positive electrode plate composed of an oriented sintered body containing a plurality of oriented crystal grains. In the case where the positive electrode plate 12 is an oriented positive electrode plate, the oriented sintered body constituting the positive electrode plate 12 can advantageously increase the thickness of the positive electrode plate 12 compared to a non-oriented sintered body. A thick oriented positive electrode plate allows an all-solid-state lithium battery having a high energy density to be produced. In addition, the positive electrode plate 12 itself has rigidity; hence the bending action by the expansion and contraction of the positive electrode plate during charge and discharge can be reduced to prevent electrical short-circuiting and an increase in resistance from occurring due to damage, separation, or cracking of the solid electrolyte layer, leading to improvements in cycle characteristics. From the viewpoint of increasing the amount of the active material per unit area and securing the substrate-free self-supporting state, the oriented positive electrode plate preferably has a thickness of at least 20 μm, more preferably at least 30 μm, further preferably at least 40 μm, particularly preferably at least 50 μm, and most preferably at least 55 μm. The upper limit of the thickness is preferably 100 μm, more preferably 90 μm, further preferably 80 μm, and particularly preferably 70 μm, from the viewpoint of delayed deterioration of battery characteristics (in particular, an increase in resistance) during repeated charge and discharge cycles. The oriented positive electrode plate preferably has a size of 5 mm×5 mm square or more, more preferably 10 mm×10 mm to 100 mm×100 mm square, and further preferably 20 mm×20 mm to 200 mm×200 mm square, in other expression, preferably 25 mm² or more, more preferably 100 to 10000 mm², and further preferably 400 to 40000 mm².

As described above, the crystal grains are preferably lithium cobaltate crystal grains. LiCoO₂ constituting the lithium cobaltate crystal grains has a layered rock-salt structure, and in a typical oriented sintered plate used in the present invention, at least one of the (104) plane and (101) plane of lithium cobaltate is oriented in parallel to the plate surface of the oriented positive electrode plate. This can be determined from the XRD profile of the plate surface showing that the ratio of the diffraction peak intensity assigned to least one of the (104) plane and (101) plane to the diffraction peak intensity assigned to the (003) plane is higher than the ratio in the XRD profile of the pulverized powder. The lithium cobaltate oriented sintered plate may further contain a very small amount of one or more elements, such as Mg, AI, Si, Ca, Ti, V, Cr, Fe, Cu, Zn, Ga, Ge, Sr, Y, Zr, Nb, Mo, Ag, Sn, Sb, Te, Ba, and Bi, in a dopant or similar form (e.g., solid-solution, segregation, coating, or adhesion to a part of the surface layer of a crystal grain) within a range not departing from the gist of the present invention. Regarding the degree of orientation, it is advantageous for output performance that the lithium ion conductive surface is oriented as near the direction vertical to the plate surface as possible, but the amount of the expansion and contraction amount during charge and discharge is increased, leading to a disadvantage in cycle characteristics. Accordingly, the direction and the degree of the orientation may be appropriately selected according to the desired battery performance.

The positive electrode plate 12 is not necessarily an oriented positive electrode plate and may be a non-oriented positive electrode plate. The non-oriented positive electrode plate 12 preferably includes six or less primary grains, on average, of the crystal grains residing in the thickness direction vertical to the plate surface. In such a configuration, the number of grain boundaries between primary grains in the lithium ion conducting direction is small, and the lithium ion conductivity in the positive electrode plate can be improved. Accordingly, the positive electrode plate in this configuration can also be called positive electrode plate containing reduced grain boundaries. The positive electrode plate containing reduced grain boundaries should not be limited to the non-oriented positive electrode plate and may be an oriented positive electrode plate. The employment of such a positive electrode plate containing reduced grain boundaries can improve the rate characteristics and the cycle characteristics of the all-solid-state lithium battery. The average number of primary grains residing in the thickness direction can be determined by polishing the positive electrode plate with a cross section polisher (CP) to expose a cross-section and taking and analyzing a cross-sectional SEM image. Specifically, the average number of primary grains residing in the thickness direction is determined by drawing five perpendicular lines at arbitrary positions on the cross-sectional SEM image and calculating the arithmetical mean of the number of primary grains crossing the respective five perpendicular lines.

The positive electrode plate containing reduced grain boundaries preferably has a thickness of at least 20 μm, more preferably at least 30 μm, further preferably at least 40 μm, further more preferably at least 45 μm, particularly preferably at least 50 μm, and most preferably at least 55 μm, from the viewpoint of increasing the amount of the active material per unit area and securing the substrate-free self-supporting state. A thick oriented positive electrode plate allows an all-solid-state lithium battery with a high energy density to be produced. In addition, the positive electrode plate 12 itself has rigidity;

hence the bending action by the expansion and contraction of the positive electrode plate during charge and discharge can be suppressed to prevent electrical short-circuiting and an increase in resistance from occurring due to damage, separation, or cracking of the solid electrolyte layer, leading to improvements in cycle characteristics. The upper limit of the thickness is preferably 200 μm, more preferably 100 μm, further preferably 90 μm, particularly preferably 80 and most preferably 70 μm, from the viewpoint of delayed deterioration of battery characteristics (in particular, an increase in resistance) during repeated charge and discharge cycles. In particular, not only the rate characteristics and the cycle characteristics but also the energy density can be enhanced by control of the thickness of the positive electrode plate to 35 μm or more and the average number of primary grains residing in the thickness direction to six or less. The average number of primary grains residing in the thickness direction is preferably three or less. In such a case, the lithium ion conductivity in the positive electrode plate can be further improved. The size of the positive electrode plate containing reduced grain boundaries is preferably 5 mm×5 mm square or more, more preferably 10 mm×10 mm to 100 mm×100 mm square, and further preferably 20 mm×20 mm to 200 mm×200 mm square, in other expression, preferably 25 mm² or more, more preferably 100 to 10000 mm², and further preferably 400 to 40000 mm².

The multiple primary grains in the positive electrode plate containing reduced grain boundaries preferably include primary grains exposing to either of the two surfaces of the positive electrode plate. Since the portion of a primary grain exposing to either of the surfaces substantially has no grain boundary, the lithium ion conductivity can be further improved. The proportion of the number of the primary grains exposing to the surfaces to the total number of the primary grains is preferably 10% or more and more preferably 25% or more. In the case where the primary grains are all exposed to the surfaces, the average number of the primary grains residing in the thickness direction is one. The average number of primary grains residing in the thickness direction can be determined by drawing five perpendicular lines at arbitrary positions on an SEM image and calculating the arithmetical mean of the number of primary grains crossing the respective five perpendicular lines. The primary grains may have any average circle equivalent diameter, and the average circle equivalent diameter can be 5 μm or more and 100 μm or less and is preferably 10 μm or more and more preferably 20 μm or more. The average circle equivalent diameter is the arithmetic mean value of diameters of ten perfect circles having the same cross-sectional areas of ten primary grains.

The sintered body in the positive electrode plate 12 preferably has a density of 90% or more, more preferably 90% to 98%, further preferably 92% to 98%, and particularly preferably 92% to 95%. The density can be calculated by measuring the bulk density of the sintered body by the Archimedes method and dividing the bulk density by the true density.

Although a higher density is basically preferred from the viewpoint of capacity and energy density, an increase in the resistance value during repeated charge and discharge cycles is prevented within the above-mentioned range of the density. It is believed that the positive electrode plate 12 having a density within the above-mentioned range can be appropriately expanded and contracted by the intercalation and deintercalation of lithium, resulting in relief of the stress.

The positive electrode plate 12 preferably includes an electrically conductive film 12a having a thickness of 0.01 μm or more and less than 5 μm on the surface away from the solid electrolyte layer 14 (the surface adjacent to the positive electrode current collector 20). Such a configuration can enhance the electron conductivity between the positive electrode current collector 20 and the positive electrode plate 12 to further reduce the contact resistance at the interface. The electrically conductive film 12a is preferably composed of a metal and/or carbon. The metal constituting the electrically conductive film 12a may be any metal that shows a low electron conduction resistance for the positive electrode current collector 20 and the positive electrode plate 12 and does not disadvantageously affect the characteristics of the positive electrode plate 12. Preferred examples of the electrically conductive film 12a include a sputtered Au layer and a sputtered Si layer. Alternatively, a carbon layer may be used instead of the metal electrically conductive film such as the sputtered Au layer. The electrically conductive film 12a has a thickness of 0.01 μm or more and less than 5 μm, preferably 0.02 μm or more and 2 μm or less, more preferably 0.02 μm or more and 1 pm or less, further preferably 0.04 μm or more and 1 μm or less, and particularly preferably 0.05 μm or more and 1 μm or less.

### Solid Electrolyte Layer

The lithium-ion conductive material of the solid electrolyte layer 14 is preferably a garnet ceramic material, a nitride ceramic material, a perovskite ceramic material, a phosphate ceramic material, a sulfide ceramic material, or a polymer material, and more preferably at least one selected from the group consisting of a garnet ceramic material, a nitride ceramic material, a perovskite ceramic material, and a phosphate ceramic material. Examples of the garnet ceramic material include a Li—La—Zr—O material (in specific, Li₇La₃Zr₂O₁₂), a Li—La—Ta—O material (in specific, Li₇La₃Ta₂O₁₂). Examples of the nitride ceramic material include Li₃N. Examples of the perovskite ceramic material include Li—La—Zr—O materials (in specific, LiLa₁₋ₓTiₓO₃ (0.04≤x≤0.14)). Examples of the phosphate ceramic material include lithium phosphate, nitrogen-doped lithium phosphate (LiPON), Li—Al—Ti—P—O, Li—Al—Ge—P—O, and Li—Al—Ti—Si—P—O (in specific, Li_{1+x+y}AlₓTi₂₋ₓSi_{y}P_{3-y}O₁₂ (0≤x≤0.4 and 0<y≤0.6)).

The lithium-ion conductive material of the solid electrolyte layer 14 is preferably composed of a Li—La—Zr—O ceramic material and/or a lithium phosphate oxynitride (LiPON) ceramic material. The Li—La—Zr—O material is a sintered oxide having a garnet or pseudo-garnet crystal structure containing Li, La, Zr, and O, specifically, a garnet ceramic material, such as Li₇La₃Zr₂O₁₂. The garnet ceramic material is a lithium-ion conductive material which does not react with lithium in the negative electrode even after direct contact. In particular, a sintered oxide having a garnet-type or pseudo-garnet-type crystal structure containing Li, La, Zr, and O has excellent sintering properties, is readily densified, and has high ion conductivity. The garnet-type or pseudo-garnet-type crystal structure having such a composition is called an LLZ crystal structure and has an XRD pattern similar to that in X-ray diffraction file No. 422259 (Li₇La₃Zr₂O₁₂) in Cambridge Structural Database (CSD). The structure may have constituent elements different from that in No. 422259 and may have a Li content in the ceramic different from that in No. 422259, and thus may have a diffraction angle and diffraction intensity profile different from that in No. 422259. Preferably, the molar ratio Li/La of Li to La is 2.0 or more and 2.5 or less, and the molar ratio Zr/La of Zr to La is 0.5 or more and 0.67 or less. The garnet-type or pseudo-garnet-type crystal structure may further contain Nb and/or Ta. That is, partial replacement of Zr in LLZ with Nb and/or Ta improves conductivity in comparison to before the replacement. Preferably, Zr is replaced with Nb and/or Ta such that the molar ratio (Nb+Ta)/La is 0.03 or more and 0.20 or less. It is preferred that the garnet sintered oxide further contain Al, and these elements may be present in the crystal lattice or at positions other than the crystal lattice. Preferably, Al is added in an amount of 0.01 to 1 mass % of the sintered oxide, and the molar ratio Al/La of Al to La is 0.008 to 0.12. Such an LLZ ceramic is prepared according to or by appropriately modifying a known process. Lithium phosphate oxynitride (LiPON) ceramic materials are also preferred. LiPON is a compound group represented by the composition of Li_{2.9}PO_{3.3}N_{0.46} and is a compound group denoted by, for example, LiₐPO_{b}N_{c} (where, a is 2 to 4; b is 3 to 5; and c is 0.1 to 0.9).

Although the solid electrolyte layer 14 may have any size, its thickness is preferably 0.0005 to 0.1 mm, more preferably 0.001 to 0.05 mm, further preferably 0.002 to 0.02 mm, and particularly preferably 0.003 to 0.01 mm, in view of charge-discharge rate characteristics and mechanical strength.

The solid electrolyte layer 14 may be formed by a grain jet coating process, a solid phase process, a solution process, or a gas phase process. Examples of the grain jet coating process include aerosol deposition (AD), gas deposition (GD), powder jet deposition (PJD), cold spraying (CS), and flame coating. The aerosol deposition (AD) is particularly preferred because it can be carried out at room temperature without a variation in a composition during the process or formation of a high-resistance layer by the reaction with a positive electrode plate. Examples of the solid phase process include tape lamination processes and printing processes. Tape lamination processes are preferred because they can form a thin solid electrolyte layer 14 and facilitate the thickness control. Examples of the solution process include solvothermal synthesis, hydrothermal synthesis, sol-gel processes, precipitation processes, microemulsion processes, and solvent evaporation processes. Hydrothermal synthesis is particularly preferred among these processes because it can readily yield highly crystalline crystal grains at low temperature. Microcrystals synthesized by these processes may be deposited or directly precipitated on the positive electrode. Examples of the gas phase process include laser deposition (PLD), sputtering, evaporation-condensation (PVD), chemical vapor deposition (CVD), vacuum deposition, and molecular beam epitaxy (MBE). The sputtering is particularly preferred because it causes a small variation in a composition and readily yields a film having relatively high adhesion.

The interface between the positive electrode plate 12 and the solid electrolyte layer 14 may be treated for reducing the interface resistance. For example, the surface of the positive electrode plate 12 and/or the solid electrolyte layer 14 is coated with niobium oxide, titanium oxide, tungsten oxide, tantalum oxide, lithium-nickel composite oxide, lithium-titanium composite oxide, a lithium-niobium compound, a lithium-tantalum compound, a lithium-tungsten compound, a lithium-titanium compound, or any combination or composite oxide thereof. Although such treatment forms a coat at the interface between the positive electrode plate 12 and the solid electrolyte layer 14, the thickness of the coat is significantly small, such as 20 nm or less.

### Negative Electrode Layer

The negative electrode layer 16 contains lithium and is typically composed of lithium metal. The negative electrode layer 16 may be prepared by placing foil of lithium metal on the solid electrolyte layer 14 or the negative electrode current collector 24 or by forming a thin lithium metal layer on the solid electrolyte layer 14 or the negative electrode current collector 24 by vacuum deposition, sputtering, CVD, or any other process.

Although the negative electrode layer 16 may have any size, the thickness is preferably 10 μm or more, more preferably 50 to 10 μm, further preferably 40 to 10 μm, and particularly preferably 20 to 10 μm, from the viewpoint of securing a large total amount of lithium in the all-solid-state lithium battery 10 including a thick positive electrode plate 12.

### Intermediate Layer

An intermediate layer may be disposed between the negative electrode layer 16 and the solid electrolyte layer 14, if desired. In detail, the all-solid-state lithium battery 10 can further include an intermediate layer containing a metal alloyable with lithium on the surface of the solid electrolyte layer 14, the surface being adjacent to the negative electrode layer 16. The intermediate layer can be composed of a metal alloyable with lithium or an oxide material. Such a case can significantly reduce the melt of lithium metal even if the intermediate layer is applied to a heating process (e.g., a process performed at a temperature of 200° C. or more), such as a reflow soldering process, and thus can effectively prevent internal short-circuiting and separation of the negative electrode layer. In addition, such a case can improve the charge and discharge cycle characteristics. The metal alloyable with lithium preferably is at least one metal selected from the group consisting of aluminum (Al), silicon (Si), zinc (Zn), gallium (Ga), germanium (Ge), silver (Ag), gold (Au), platinum (Pt), cadmium (Cd), indium (In), tin (Sn), antimony (Sb), lead (Pb), and bismuth (Bi), more preferably at least one selected from the group consisting of Au, In, Si, Sn, Zn, and Al. For example, a preferred metal alloyable with lithium may be at least one selected from Au and In. The metal alloyable with lithium may be an alloy composed of two or more elements, such as Mg₂Si and Mg₂Sn. Examples of the oxide material include Li₄Ti₅O₁₂, TiO₂, and SiO. The intermediate layer may be formed by a known method, such as aerosol deposition (AD), pulse laser deposition (PLD), sputtering, or evaporation. Although the intermediate layer may have any size, the thickness is preferably 0.05 to 1 μm, more preferably 0.05 to 0.5 μm, further preferably 0.08 to 0.2 μm, and particularly preferably 0.1 to 0.15 μm, from the viewpoint of enhanced alloying during heating. Since the materials exemplified as the intermediate layer themselves contribute to charge and discharge as a negative electrode, the negative electrode may be composed of at least one selected from these materials.

### End Insulator

An end insulator 18 may be disposed so as to insulate and cover the ends of the solid electrolyte layer 14, if desired. The end insulator 18 preferably contains an organic polymer material that can come into contact or tight contact with the solid electrolyte layer 14. The end insulator 18 containing such an organic polymer material can more effectively prevent short-circuiting between the positive electrode plate 12 and the negative electrode layer 16. The organic polymer material is preferably at least one selected from the group consisting of binders, heat melting resins, and adhesives. Preferred examples of the binder include cellulose resins, acrylic resins, and combinations thereof. Preferred examples of the heat melting resin include fluororesins, polyolefin resins, and combinations thereof. The heat melting resin is preferably supplied in the form of a heat-melting film as described below. Preferred examples of the adhesive include thermosetting adhesives containing thermosetting resins, such as epoxy resins. Accordingly, the organic polymer material is preferably at least one selected from the group consisting of cellulose resins, acrylic resins, fluororesins, polyolefin resins, and epoxy resins. Examples of the cellulose resin include carboxymethyl cellulose, carboxyethyl cellulose, hydroxyethyl cellulose, hydroxypropyl cellulose, cellulose butyrate, cellulose acetate butyrate, and their alkali metal salts and ammonium salts. Examples of acrylic resin include polyacrylic esters, polyacrylates, and their maleic anhydride modified products, maleic acid modified products, and fumaric acid modified products. Examples of the fluororesin include poly(vinylidene fluoride) (PVdF), polytetrafluoroethylene (PTFE), tetrafluoroethylene-perfluoalkyl vinyl ether copolymers (PFA), tetrafluoroethylene-hexafluoropropylene copolymers (FEP), polychlorotrifluoroethylene (PCTFE), tetrafluoroethylene-hexafluoropropylene-vinylidene fluoride copolymers, hexafluoropropylene-vinylidene fluoride copolymers, and their maleic anhydride modified products, maleic acid modified products, and fumaric acid modified products. Examples of the polyolefin resin include polyethylene, polypropylene, cycloolefin polymers, and their maleic anhydride modified products, maleic acid modified products, and fumaric acid modified products.

The end insulator 18 is preferably formed by application of a solution or slurry containing an organic polymer material (preferably a binder) and optional components, such as a filler. The solution or slurry is preferably applied by, for example, dispensing, screen printing, spraying, or stamping.

### Negative Electrode Current Collector

The negative electrode current collector 24 is preferably disposed on the outside of the negative electrode layer 16. The negative electrode current collector 24 may also serve as a negative electrode cladding covering the outside of the negative electrode. For example, as illustrated in FIG. 4, contrary to the structure illustrated in FIG. 1, the all-solid-state lithium battery 10 may include two unit cells stacked so as to have horizontal line symmetry about a single positive electrode current collector 20 disposed between the unit cells to expose the negative electrode current collector 24 to the outside of the all-solid-state lithium battery 10. In such a battery composed of cells stacked in parallel, the positive electrode current collector 20 can function as a current collector common to the two adjoining unit cells.

The negative electrode current collector 24 and the positive electrode current collector 20 may be composed of the same material or different materials and are preferably composed of the same material. The metal constituting the negative electrode cladding 24 may be any metal or alloy that does not react with the negative electrode layer 16. Preferred examples of such a metal include stainless steel, aluminum, copper, platinum, and nickel, and stainless steel is more preferred. The negative electrode current collector 24 is preferably a metal plate or metal foil and more preferably metal foil. Accordingly, the most preferred current collector is stainless steel foil. The metal foil preferably has a thickness of 1 to 30 μm, more preferably 5 to 25 μm, and most preferably 10 to 20 μm.

### End Seal

The all-solid-state lithium battery 10 preferably further includes an end seal 26 composed of a sealing material. The end seal 26 seals the positive electrode plate 12, the solid electrolyte layer 14, the negative electrode layer 16, and (if existing) the end insulator 18 in the exposed portions not covered by the positive electrode current collector 20 or the negative electrode current collector 24. High resistance to humidity (desirably resistance to humidity at high temperature) can be achieved by disposing the end seal 26 so as to seal the positive electrode plate 12, the solid electrolyte layer 14, the negative electrode layer 16, and the end insulator 18 in the exposed portions not covered by the positive electrode current collector 20 or the negative electrode current collector 24. As a result, undesired moisture can be effectively prevented from infiltrating into the all-solid-state lithium battery 10, leading to an improvement in battery characteristics. The end seal 26 is composed of a sealing material. The sealing material may be any material that can seal the exposed portions not covered by the positive electrode current collector 20, the negative electrode current collector 24, or the end insulator 18 and can achieve high resistance to humidity (desirably resistance to humidity at high temperature). It should be understood that the sealing material ensures electrical insulation between the positive electrode current collector 20 and the negative electrode current collector 24. In this reason, the sealing material preferably has a resistivity of 1×10⁶ Ωcm or more, more preferably 1×10⁷ Ωcm or more, and most preferably 1×10⁸ Ωcm or more. Such a resistivity can significantly reduce the self-discharge.

The end seal 26 preferably has a thickness of 10 to 300 μm, more preferably 15 to 200 μm, and most preferably 20 to 150 μm. In particular, in the case where the battery is covered by a positive electrode current collector or a negative electrode current collector composed of metals, infiltration of moisture into the battery is caused only by permeation through the end seal 26 because the metals constituting the positive electrode current collector and the negative electrode current collector block permeation of moisture. Accordingly, a decrease in the thickness of the end seal 26 (i.e., a reduction in the area of inlet for moisture to infiltrate) or an increase in the width of the end seal 26 (i.e., an increase in the path for moisture to infiltrate) decreases the amount of moisture infiltrated into the battery, namely, improves the resistance to humidity. The thickness within the above-mentioned range is preferred from such a viewpoint.

The width of the end seal 26 (in other words, the thickness of the end seal 26 in the direction of the surface of the solid electrolyte layer 14) is preferably 0.5 to 3 mm, more preferably 0.7 to 2 mm, and most preferably 1 to 2 mm. A width within the above-mentioned range can achieve a high volume energy density of the battery without excessively enlarging the end seal 26.

The sealing material preferably a resin sealing material containing a resin. In such a case, the end seal 26 can be formed at a relatively low temperature (e.g., 400° C. or less). As a result, the battery can be effectively prevented from destruction or deterioration caused by sealing with heating. The resin preferably has a coefficient of thermal expansion of 7×10⁻⁶/° C. or more, more preferably 9×10⁻⁶ to 20×10⁻⁶/° C., more preferably 10×10⁻⁶ to 19×10⁻⁶/° C., more preferably 12×10⁻⁶ to 18×10⁻⁶/° C., and most preferably 15×10⁻⁶ to 18×10⁻⁶/° C. The resin is preferably an insulative resin. The insulative resin is preferably an adhesive having insulative properties (adhesive resin bondable by heat or with an adhesive, for example). Preferred examples of the insulative resin include olefin resins, fluororesins, acrylic resins, epoxy resins, urethane resins, and silicon resins Particularly preferred examples of the resin are low moisture permeable resins serving as sealing materials and include adhesive resins having heat sealing properties and low moisture permeability, such as polypropylene (PP), polyethylene (PE), cycloolefin polymers, polychlorotrifluoroethylene (PCTFE), and their maleic anhydride modified products, maleic acid modified products, and fumaric acid modified products. The insulative resin may be composed of one or more stacked products. At least one insulative resin may be a thermoplastic resin-molded sheet or a resin including a reactive adhesive component. The resin sealing material may be a mixture of a resin (preferably an insulative resin) and an inorganic material. Preferred examples of the inorganic material include silica, alumina, zinc oxide, magnesia, calcium carbonate, potassium hydroxide, barium sulfate, mica, and talc. More preferably, the inorganic material is silica. For example, a resin sealing material composed of an epoxy resin and silica is preferred.

The end seal 26 may be formed by, for example, lamination (thermal fusion or adhesion with an adhesive) of resin films or dispensing of a liquid resin to the positive electrode current collector. The gap formed between the end seal 26 and the end sides of the positive electrode plate 12, the solid electrolyte layer 14, and the negative electrode layer 16 are preferably sufficiently filled with the end insulator 18.

Alternatively, the sealing material may be a glass sealing material containing glass. The glass sealing material preferably contains at least one element selected from the group consisting of V, Sn, Te, P, Bi, B, Zn, and Pb from the view of readily expressing desired softening temperature and coefficient of thermal expansion. These elements are present in glass in the forms of V₂O₅, SnO, TeO₂, P₂O₅, Bi₂O₃, B₂O₃, ZnO, and PbO. The glass sealing material preferably does not contain Pb and PbO that may be harmful. The glass sealing material preferably has a softening temperature of 400° C. or less, more preferably 370° C. or less, and most preferably 350° C. or less. Although the softening temperature has no lower limit, the lower limit can be, for example, 300° C. or more, 310° C. or more, or 320° C. or more. The use of a glass sealing material having a relatively low softening temperature allows the end seal 26 to be formed at a relatively low temperature. As a result, the battery can be effectively prevented from destruction or deterioration caused by sealing with heating. The glass sealing material preferably has a coefficient of thermal expansion of 7×10⁻⁶/° C. or more, more preferably 9×10⁻⁶ to 20×10⁻⁶/° C., more preferably 10×10⁻⁶ to 19×10⁻⁶/° C., more preferably 12×10⁻⁶ to 18×10⁻⁶/° C., and most preferably 15×10⁻⁶ to 18×10⁻⁶/° C. Since the coefficient of thermal expansion within such a range is similar to that of a metal, the joint of the current collector composed of a metal (i.e., the positive electrode current collector 20 and/or the negative electrode current collector 24) and the end seal 26 can be effectively prevented from being damaged by a thermal shock. Glass sealing materials satisfying the above-described characteristics are commercially available.

Examples of the glass sealing materials satisfying the above-described characteristics include “POWDER GLASS” (AGC glass frit) and “GLASS PASTE” (AGC glass paste) product families available from AGC Electronics Co., Ltd., a Low Melting Point Glass Paste product family available from Central Glass Co., Ltd., and a “Vaneetect” product family of vanadium low-melting-point glass available from Hitachi Chemical Co., Ltd.

### Thickness of Battery

The all-solid-state lithium battery including one unit cell preferably has a thickness of 60 to 5000 μm, more preferably 70 to 4000 μm, more preferably 80 to 3000 μm, more preferably 90 to 2000 μm, and most preferably 100 to 1000 μm. According to the present invention, the positive electrode plate can have a relatively large thickness while the current collector also functions as a cladding; hence, the battery can have a relatively small thickness.

### Method for Producing Lithium Cobaltate Oriented Sintered Plate

According to a preferred embodiment of the present invention, a lithium cobaltate oriented sintered plate is produced by (a) preparing a green sheet containing Co₃O₄ grains, (b) firing the green sheet at 900° C. to 1450° C. into a fired intermediate, (c) cooling the fired intermediate into a Co₃O₄ oriented sintered plate containing a Co₃O₄ phase, and (d) introducing lithium into the Co₃O₄ oriented sintered plate. Each step of the production process of the present invention will now be described in detail.

### (a) Preparation of Green Sheet

In step (a), a green sheet containing Co₃O₄ grains and having a thickness of 100 μm or less is prepared. Preferably, the green sheet preferably further contains bismuth oxide (typically, Bi₂O₃ grains) as a grain growth accelerator. The green sheet may be produced by shaping a raw material containing Co₃O₄ grains and optionally bismuth oxide (typically, Bi₂O₃ grains) into a sheet. Although the raw material may contain any amount of Bi₂O₃ grains, the amount of the Bi₂O₃ grains is preferably 0.1 to 30 wt %, more preferably 1 to 20 wt %, and most preferably 3 to 10 wt % based on the total amount of the Co₃O₄ grains and the Bi₂O₃ grains. The Co₃O₄ grains preferably have a volume D50 grain diameter of 0.1 to 2.0 μm and more preferably 0.3 to 1.2 μm. The Bi₂O₃ grains preferably have a volume D50 grain diameter of 0.1 to 1.0 μm and more preferably 0.2 to 0.5 μm. The green sheet has a thickness of 100 mm or less, preferably 1 to 90 μm, and more preferably 5 to 60 μm. The green sheet may contain CoO grains and/or Co(OH)₂ grains instead of all or part of the Co₃O₄ grains. In also such a case, the green sheet can be formed into a CoO fired intermediate in which the (h00) plane is oriented so as to be parallel to the sheet surface by subjecting the green sheet to the firing in step (b). As a result, a lithium cobaltate oriented sintered plate can be produced as in the case of use of a green sheet containing Co₃O₄ grains.

Examples of the method of forming a green sheet include (i) doctor blading using a slurry containing feedstock grains, (ii) a drum dryer-using method including applying a slurry containing a raw material onto a heated drum to be dried thereon and scraping the dried product with a scraper, (iii) a disk drying method including applying a slurry onto a surface of heated disk to be dried thereon and scraping the dried product with a scraper, and (iv) an extrusion method using a green composition containing feedstock grains. A particularly preferred sheet-forming method is doctor blading. In doctor blading, the green sheet may be prepared by applying a slurry onto a flexible plate (for example, an organic polymer plate, such as a PET film), drying and solidifying the applied slurry to into a shaped product, and separating the shaped product from the plate. In the preparation of the slurry or the green composition before shaping, inorganic grains may be dispersed in a dispersant, and, for example, a binder and a plasticizer may be appropriately added thereto. Preferably, the slurry is prepared so as to have a viscosity of 500 to 4000 cP and is defoamed under reduced pressure.

### (b) Preparation of Fired Intermediate (Firing Step)

In step (b), the green sheet is fired at 900° C. to 1450° C. into a firing intermediate in which all or part (desirably all) of the Co₃O₄ grains are converted to CoO having the (h00) plane (h is any integer, e.g., h is 2) oriented so as to be parallel to the sheet surface. That is, the oxide of Co is phase-transformed from the spinel structure represented by Co₃O₄ at room temperature to the rock-salt structure represented by CoO at 900° C. or more (e.g., 920° C. or more). The firing reduces all or part of Co₃O₄ to cause phase transformation into CoO, and the sheet is densified. The Co₃O₄ grains before firing has an isotropic form, and the green sheet is not oriented at first. However, the Co₃O₄ grains are phase-transformed to CoO by firing, and orientation occurs in the grain growth stage (hereinafter, referred to as CoO orientation grain growth). In particular, the orientation grain growth of CoO is accelerated in the presence of bismuth oxide (typically Bi₂O₃). In a green sheet containing bismuth oxide, bismuth volatizes during the firing and is removed from the sheet. The green sheet is fired at 900° C. to 1450° C., preferably 1000° C. to 1300° C., and more preferably 1100° C. to 1300° C. The green sheet is preferably fired for 1 to 20 hours, more preferably 2 to 10 hours, at the above-mentioned firing temperature.

The thickness of 100 μm or less of the green sheet contributes to the orientation grain growth of CoO. In detail, in a green sheet having a thickness of 100 μm or less, the amount of materials present in the thickness direction is extremely smaller than that in the sheet surface direction (direction orthogonal to the thickness direction). Accordingly, in the early stage at which multiple grains are present in the thickness direction, the grain growth occurs in random directions. After the grain growth proceeds and the materials in the thickness direction are consumed, the direction of the grain growth is limited to the two-dimensional directions of the sheet surface (hereinafter, referred to as surface direction). This certainly promotes the grain growth in the surface direction. In particular, even if the green sheet is formed as thin as possible (e.g., several micrometers or less) or the green sheet has a relatively thick (about 100 μm at most, e.g., about 20 μm), the grain growth is certainly promoted in the surface direction at a grain growth rate as high as possible. Ultimately, in firing, grain growth into a flat (tabular) shape in the plane direction selectively occurs in only the grains having the crystal face of the lowest surface energy in the plane of the green sheet. As a result, the firing of the green sheet provides a fired intermediate having a large aspect ratio and composed of CoO tabular crystal grains of which the (h00) plane is oriented so as to be parallel to the plate surface of the grain, the CoO tabular crystal grains being oriented such that the (h00) plane is parallel to the sheet surface and being bonded to each other in the surface direction at the grain boundaries.

### (c) Preparation of Oriented Sintered Plate (Cooling Step)

Step (c) is a cooling step subsequently performed after the firing in step (b) (i.e., cooling from the firing temperature). In detail, step (c) involves cooling the fired intermediate (from the firing temperature in step (b)) to be reverted from Co₃O₄ to a Co₃O₄ oriented sintered plate containing a Co₃O₄ phase. The Co₃O₄ oriented sintered plate may contain partially remaining CoO. The cooling rate after the firing is preferably 10° C./h to 200° C./h and more preferably 20° C./h to 100° C./h.

In step (c) or the process of cooling the fired intermediate, CoO is oxidized into Co₃O₄. In this step, the orientation direction of CoO is succeeded by Co₃O₄ to give Co₃O₄ crystal grains having the (h00) plane oriented so as to be parallel to the plate surface of the grain. As a result, an independent plate or sheet composed of a large number of Co₃O₄ grains having the (h00) plane oriented so as to be parallel to the sheet plane is formed. The “independent” sheet indicates a sheet that can be handled alone separately from a support after the firing. That is, the “independent” sheet does not include a sheet fixed to and integrated with (nor readily separable from) a support (such as a substrate) by firing. Thus, the resulting self-supporting oriented sintered plate is composed of a large number of grains of which the (h00) plane is oriented so as to be parallel to the plate face of the grains. The self-supporting plate can be a dense ceramic sheet composed of a large number of grains closely bonded to each other, as described above.

### (d) Introduction of Lithium

In step (d), lithium is introduced into the Co₃O₄ oriented sintered plate to form a lithium cobaltate oriented sintered plate composed of LiCoO₂. Lithium is preferably introduced by reacting the Co₃O₄ oriented sintered plate with a lithium compound. Examples of the lithium compound for introducing lithium include (i) lithium hydroxide, (ii) lithium salts, such as lithium carbonate, lithium nitrate, lithium acetate, lithium chloride, lithium oxalate, and lithium citrate, and (iii) lithium alkoxides, such as lithium methoxide and lithium ethoxide. Particularly preferred lithium compounds are lithium carbonate and lithium hydroxide. Conditions for introducing lithium, such as the mixing ratio, heating temperature, heating time, and atmosphere, may be appropriately set in view of, for example, the melting point, decomposition temperature, and reactivity of the material used as the lithium source. For example, lithium can be introduced into Co₃O₄ grains by placing a predetermined amount of lithium carbonate on the (h00)-oriented Co₃O₄ oriented sintered plate and heating them. Although lithium carbonate may be placed on a sheet containing lithium carbonate, it is preferred to place the Co₃O₄ oriented sintered plate between lithium-containing sheets for introducing a sufficient amount of lithium into, in particular, a thick oriented sintered plate. The lithium-containing sheets are preferably formed by preparing a slurry of lithium carbonate and shaping the slurry into a tape form. The slurry may be shaped by the method described in step (a). The thickness of the lithium-containing sheet may be appropriately determined so as to provide lithium carbonate in an amount to give a desired Li/Co ratio and is, for example, 20 to 60 μm. Alternatively, lithium may be introduced into Co₃O₄ grains by another method, e.g., by applying a predetermined amount of a slurry of LiOH powder to the (h00)-oriented Co₃O₄ oriented sintered plate, and drying and then heating them. In both methods, the heating temperature is preferably 700° C. to 900° C., and heating within this temperature range is preferably performed for 2 to 30 hours. The amount of the lithium compound adhering to the Co₃O₄ oriented sintered plate is preferably 1.0 or more as the Li/Co ratio (i.e., molar ratio of the amount of Li contained in the lithium compound to the amount of Co contained in the Co₃O₄ oriented sintered plate), more preferably 1.0 to 4.0, and further preferably 1.2 to 3.0. Even if the amount of Li is excessive, the excess portion of Li volatiles during heating to disappear without any problem.

In the resulting lithium cobaltate oriented sintered plate, at least one of the (101) plane and the (104) plane of LiCoO₂ is oriented so as to be parallel to the plate face. Accordingly, the (101) plane or the (104) plane favorable for the intercalation and deintercalation of lithium ions is oriented so as to be parallel to the plate face of the oriented sintered plate. Consequently, in a battery including such an oriented sintered plate as the positive-electrode active material, a larger area of the plane is exposed to (in contact with) the electrolyte, and the exposing ratio of the (003) plane (plane unfavorable for the intercalation and deintercalation of lithium ions) is extremely low in the surfaces of the grains and the plate. Accordingly, the lithium cobaltate oriented sintered plate used as a positive electrode material of a solid type lithium secondary battery achieves high capacity and high-rate characteristics at the same time.

As described above, the lithium cobaltate oriented sintered plate may contain one or more elements such as Mg, Al, Si, Ca, Ti, V, Cr, Fe, Cu, Zn, Ga, Ge, Sr, Y, Zr, Nb, Mo, Ag, Sn, Sb, Te, Ba, Bi, Ni, and Mn within a range not departing from the gist of the present invention, and such an element may be added in any of the above-described steps (a) to (d) (typically, in step (a) or step (d)). In the case of allowing segregation or adhesion of such an element to only the surface of the plate, for example, the plate may be further covered by the element after step (d) and subjected to heat treatment.

### Method of Producing Sintered Plate Containing Reduced Lithium Complex Oxide Grain Boundaries

According to a preferred embodiment of the present invention, a sintered plate containing reduced lithium complex oxide grain boundaries is produced by (a) preparing a shaped product of a feedstock powder of a transition metal compound, (b) firing the shaped product of the feedstock powder of the transition metal compound, (c) preparing a lithium source, (d) synthesizing a lithium complex oxide, and (e) coarsening the primary grains. Each step of the production process of the present invention will now be described in detail.

### (a) Preparation of Shaped Product of Feedstock Powder of Transition Metal Compound

A feedstock powder containing a transition metal (e.g., Co, Ni, or Mn) compound is prepared. The feedstock powder of the transition metal compound may be free from a lithium compound. Although the feedstock powder of the transition metal compound may have any average grain diameter, appropriate cavities should be preferably formed in the shaped product described below, hence, the feedstock powder may be coarse grains. The feedstock powder of the transition metal compound may be pulverized and classified according to need. In addition, according to the target composition, feedstock powder of several transition metal compounds may be appropriately mixed. Furthermore, in order to promote the grain growth, the feedstock powder of the transition metal compound may contain a very small amount (e.g., 0.001 to 1 wt %) of low melting point oxide, for example, boron oxide, bismuth oxide, or antimony oxide; low melting point chloride, for example, sodium chloride or potassium chloride; or low melting point glass, for example, borosilicate glass.

Subsequently, a shaped product of the feedstock powder of the transition metal compound is produced by doctor blading or compaction molding using a slurry of the feedstock powder of the transition metal compound. A method of producing a transition metal green sheet by doctor blading will now be described as one example of the production process. The feedstock powder of the transition metal compound, a dispersant (e.g., toluene or 2-propanol), a binder (e.g., polyvinyl butyral), a plasticizer (e.g., di(2-ethylhexyl)phthalate (DOP)), and a dispersant are mixed to prepare a mixture. Subsequently, the prepared mixture is stirred under reduced pressure for defoaming, and the viscosity is appropriately adjusted to prepare slurry of the transition metal compound. Subsequently, the slurry of the transition metal compound is formed into a sheet on a PET film by doctor blading to prepare a transition metal green sheet. The green sheet may have any thickness, but preferably has a thickness of 200 μm or less for decreasing the average number of primary grains residing in the thickness direction.

### (b) Step of Firing Shaped Product of Feedstock Powder of Transition Metal Compound

The shaped product of the feedstock powder of the transition metal compound disposed between setters is placed in a sheath. Subsequently, the shaped product of the feedstock powder of the transition metal compound is fired (at 500° C. to 1000° C. for 1 to 10 hours) to produce a fired product of the transition metal compound. Multiple cavities are formed inside the fired product of the transition metal compound in this step. The average circle equivalent diameter of the cavities may be 0.1 μm or more and 10 μm or less, preferably 0.2 μm or more and 8.5 μm or less, and more preferably 0.25 μm or more and 7 μm or less. The average circle equivalent diameter of the multiple cavities is the arithmetic mean value of diameters of ten perfect circles having the same cross-sectional areas of randomly selected ten cavities. The diameter of the cavities can be adjusted by the grain diameter of the feedstock powder of the transition metal compound and the firing conditions in this synthetic step. For example, the diameter of the cavities can be increased by increasing the grain diameter of the feedstock powder of the transition metal compound, and the diameter of the cavities can be decreased by raising the firing temperature or by prolonging the firing time.

### (c) Preparation of Lithium Source

Examples of the lithium source include lithium-containing green sheets, lithium-containing solutions, and lithium-containing powders. A method of producing a lithium-containing green sheet will now be described as an example. A feedstock powder containing a lithium compound (e.g., Li₂CO₃), a binder (e.g., polyvinyl butyral), a plasticizer (e.g., DOP), and a dispersant are mixed to prepare a mixture. Subsequently, the mixture is stirred under reduced pressure for defoaming, and the viscosity is appropriately adjusted to prepare a lithium-containing slurry. Subsequently, the prepared lithium-containing slurry is shaped into a lithium-containing green sheet on a PET film by doctor blading.

### (d) Step of Synthesizing Lithium Complex Oxide

The lithium source is placed on the two main surfaces of the fired product of the transition metal compound. In the case of using a lithium-containing green sheet as the lithium source, the fired product of the transition metal compound is disposed between two lithium-containing green sheets. In the case of using a lithium-containing solution as the lithium source, the lithium-containing solution is applied to the two main surfaces of the fired product of the transition metal compound. In the case of using a lithium-containing powder as the lithium source, the lithium-containing powder is sprayed on the two main surfaces of the fired product of the transition metal compound.

Subsequently, the fired product of the transition metal compound provided with the lithium source is fired (at 500° C. to 800° C. for 1 to 10 hours) into a sintered body containing bonded multiple primary grains composed of synthesized lithium complex oxide. In the case where the molar ratio of the lithium contained in the lithium source to the transition metal contained in the fired product of the transition metal compound is higher than 1.0, or where lithium is superstoichiometric, lithium may remain in the cavities of the fired product of the transition metal compound. The lithium remaining in the cavities can function as flux in the following coarsening step.

### (e) Step of Coarsening Primary Grains

The lithium source is placed on the two main surfaces of the fired product of the transition metal compound. The lithium source is placed as in the synthetic step of the lithium complex oxide described above. Subsequently, the lithium complex oxide sintered body provided with the lithium source is fired (at 800° C. to 950° C. for 1 to 20 hours). The firing temperature on this step is higher than the firing temperature for forming the lithium complex oxide sintered body. Although the mechanism of the grain growth is not sufficiently clear, a presumable mechanism is as follows. The cavities of the lithium complex oxide sintered body are filled with molten lithium, and then lithium diffuses all over the lithium complex oxide sintered body. As a result, the diffused lithium functions as flux to allow drastic grain growth of the primary grains, resulting in coarsening. As a result, a sintered plate containing reduced lithium complex oxide grain boundaries, i.e., a positive electrode plate containing reduced grain boundaries is produced. In this step, it is effective to use a lithium-containing powder placed in the firing vessel as a lithium source, in addition to the lithium source placed on the two main surfaces of the fired product of the transition metal compound. The lithium-containing powder may be placed at a position apart from the fired product of the transition metal compound.

### EXAMPLES

The present invention will now be described more specifically with reference to the following examples.

### Example 1 (Comparative)

In this example, an all-solid-state lithium battery including an oriented positive electrode plate bonded to a current collecting plate was produced and was evaluated as a comparative example.

### (1) Preparation of Oriented Positive Electrode Plate

### (1a) Preparation of Green Sheet

Bi₂O₃ (volume D50 grain diameter: 0.3 μm, available from Taiyo Koko Co., Ltd.) in an amount of 5 wt % was added to a Co₃O₄ feedstock powder (volume D50 grain diameter: 0.3 μm, available from Seido Chemical Industry Co., Ltd.) to prepare a powder mixture. A mixture composed of 100 parts by weight of this powder mixture, 100 parts by weight of a dispersant (toluene:2-propanol=1:1), 10 parts by weight of a binder (polyvinyl butyral: Product No. BM-2, available from Sekisui Chemical Co., Ltd.), 4 parts by weight of a plasticizer (di(2-ethylhexyl)phthalate (DOP), available from Kurogane Kasei Co., Ltd.), and 2 parts by weight of a dispersant (Product Name: Leodol SP-030, available from Kao Corporation) was prepared. This mixture was stirred under reduced pressure for defoaming and adjusted to a viscosity of 4000 cP. The viscosity was measured with an LVT viscometer available from Brookfield. The resulting slurry was applied onto a polyethylene terephthalate (PET) film by doctor blading and was dried into a green sheet having a dry thickness of 40 μm.

### (1b) Preparation of Oriented Sintered Plate

The green sheet was separated from the PET film and cut into a 40-mm square with a cutter. The cut sheet was placed on the center of a zirconia setter (size: 90 mm square, height: 1 mm) having embossed protrusions of 300 μm and fired at 1300° C. for 5 hours. The cut sheet was cooled at a rate of 50° C./h, and a portion of the cut sheet not adhering to the setter was taken out as a Co₃O₄ oriented sintered plate.

### (1c) Introduction of Lithium

A LiOH.H₂O powder (available from Wako Pure Chemical Industries, Ltd.) was pulverized into 1 μm or less with a jet mill and was dispersed in ethanol to prepare a slurry. This slurry was applied onto the Co₃O₄ oriented sintered plate so as to give a ratio Li/Co of 1.3 and was dried. The dried product was then placed on a zirconia setter and was heated in air at 840° C. for 20 hours. A LiCoO₂ oriented sintered plate having a thickness of 45 μm was thereby prepared as an oriented positive electrode plate. The bulk density of the resulting sintered plate was measured by the Archimedes method. The density was calculated by dividing the bulk density by the true density 5.05 g/cm³ of lithium cobaltate.

The density of the sintered plate was 97%.

### (2) Production of All-Solid-State Lithium Battery

### (2a) Preparation of Electrically Conductive Film

A gold film having a thickness of 1000 angstrom was formed on one surface of a lithium cobaltate oriented positive electrode plate by sputtering with an ion sputtering system JFC-1500 (available from JEOL Ltd.).

### (2b) Fixing of Oriented Positive Electrode Plate

The lithium cobaltate oriented sintered plate was cut into a 10-mm square, and the electrically conductive film surface of the oriented sintered plate was fixed on a stainless steel current collecting plate (positive electrode cladding, 13-mm square, 100 μm thickness) with an epoxy electrically conductive adhesive containing dispersed electrically conductive carbon to prepare a layered plate composed of an oriented positive electrode plate, an electrically conductive adhesive, and a positive electrode cladding.

### (2c) Formation of Solid Electrolyte Layer

A lithium phosphate sintered target having a dimeter of 4 inch (about 10 cm) was prepared. A gas species N₂ was brought into collision against this target at 0.2 Pa and an output of 0.2 kW by RF magnetron sputtering using a sputtering system SPF-430H (available from Canon Anelva Corporation) to form a thin film on the surface of the oriented positive electrode plate. A solid electrolyte sputtered film of a lithium phosphate oxynitride (LiPON) glass electrolyte having a thickness of 3.5 μm as a solid electrolyte layer was thereby formed on the oriented positive electrode plate.

### (2d) Formation of Negative Electrode Layer

A tungsten boat loaded with lithium metal was prepared. Li was evaporated by resistance heating with a vacuum deposition system Carbon Coater SVC-700 (available from Sanyu Electron Co., Ltd.) and deposited into a thin film on the surface of the solid electrolyte layer. In this step, the size of the negative electrode layer was adjusted to a 9.5-mm square using a mask such that the negative electrode layer fits within a 10-mm square positive electrode region. A unit cell including a deposited Li film having a thickness of 10 μm as a negative electrode layer on the solid electrolyte layer was thus produced.

### (2e) Production of End Seal

A modified polypropylene resin film (thickness: 100 μm) was laminated on the end (the periphery of the positive electrode current collecting plate) of the unit cell to produce an end seal.

### (2f) Stacking of Negative Electrode Current Collector (Negative Electrode Cladding)

A stainless steel current collecting plate having a thickness of 20 μm as a negative electrode current collector (negative electrode cladding) was stacked on the negative electrode layer of the unit cell and was heat-pressure-bonded to the negative electrode layer with a hot plate of 200° C. under reduced pressure. An all-solid-state lithium battery was thereby produced.

### (3) Evaluation of Battery

The all-solid-state lithium battery was charged at a constant current of 0.1 mA up to 3.95 V and then charged at a constant voltage up to 0.02 mA to reach the charge capacity. The battery was then discharged at a constant current of 0.1 mA down to 3.0 V. This cycle was repeated 50 times. The internal resistance R of the battery was calculated from the IR drop at 10 seconds after the start of discharge. The value obtained by dividing the internal resistance R₅₀ at the 50th discharge by the internal resistance R₅ at the 5th discharge was defined as the resistance change rate. Five batteries were produced and were evaluated, and the average resistance change rate was 170%.

### Example 2

In this example, an all-solid-state lithium battery including an oriented positive electrode plate in a state not bonded to a current collecting plate was produced and was evaluated.

### (1) Preparation of Oriented Positive Electrode Plate

### (1a) Preparation of Green Sheet

Bi₂O₃ (volume D50 grain diameter: 0.3 μm, available from Taiyo Koko Co., Ltd.) in an amount of 5 wt % was added to a Co₃O₄ feedstock powder (volume D50 grain diameter: 0.3 μm, available from Seido Chemical Industry Co., Ltd.) to prepare a powder mixture. A mixture composed of 100 parts by weight of this powder mixture, 100 parts by weight of a dispersant (toluene:2-propanol=1:1), 10 parts by weight of a binder (polyvinyl butyral: Product No. BM-2, available from Sekisui Chemical Co., Ltd.), 4 parts by weight of a plasticizer (di(2-ethylhexyl)phthalate (DOP), available from Kurogane Kasei Co., Ltd.), and 2 parts by weight of a dispersant (Product Name: Leodol SP-030, available from Kao Corporation) was prepared. This mixture was stirred under reduced pressure for defoaming and adjusted to a viscosity of 4000 cP. The viscosity was measured with an LVT viscometer available from Brookfield. The resulting slurry was applied onto a polyethylene terephthalate (PET) film by doctor blading and was dried into a green sheet having a dry thickness of 40 μm.

### (1b) Preparation of Oriented Sintered Plate

An oriented positive electrode plate of a LiCoO₂ oriented sintered plate having a thickness of 45 μm was prepared as in Example 1.

### (2) Production of All-Solid-State Lithium Battery

### (2a) Preparation of Electrically Conductive Film and Cutting of Positive Electrode Plate

A gold electrically conductive film having a thickness of 1000 angstrom was deposited on one surface of a lithium cobaltate oriented positive electrode plate by sputtering with an ion sputtering system JFC-1500 (available from JEOL Ltd.). Furthermore, the oriented positive electrode plate was cut into a 10-mm square.

### (2b) Formation of Solid Electrolyte Layer

A lithium phosphate sintered target having a dimeter of 4 inch (about 10 cm) was prepared. A gas species N₂ was brought into collision against this target at 0.2 Pa and an output of 0.2 kW by RF magnetron sputtering using a sputtering system SPF-430H (available from Canon Anelva Corporation) to form a thin film on the surface of the oriented positive electrode plate. As a solid electrolyte layer, a solid electrolyte sputtered film of a lithium phosphate oxynitride (LiPON) glass electrolyte having a thickness of 3.5 μm was thereby formed on the oriented positive electrode plate.

### (2c) Formation of Negative Electrode Layer

A tungsten boat loaded with lithium metal was prepared. Lithium was evaporated by resistance heating with a vacuum deposition system Carbon Coater SVC-700 (available from Sanyu Electron Co., Ltd.) and deposited into a thin film on the surface of the intermediate layer. In this step, the size of the negative electrode layer was adjusted to a 9.5-mm square using a mask such that the negative electrode layer fits within a 10-mm square positive electrode region. A unit cell including a deposited Li film having a thickness of 10 μm was thereby produced as a negative electrode layer on the solid electrolyte layer.

### (2d) Cladding Seal

Stainless steel foil having a thickness of 20 μm was cut into a 13-mm square as a positive electrode current collecting plate. Separately, a square frame (outer edge: 13 mm, width: 1 mm) of a modified polypropylene resin film (thickness: 100 μm) was prepared by punching out an 11-mm square central portion of the film. This frame of the resin film was placed on and thermally press-bonded to the periphery of the positive electrode current collecting plate to form an end seal. The unit cell was placed on the positive electrode current collecting plate in the region surrounded by the end seal. Similarly, stainless steel foil having a thickness of 20 μm was placed on the negative electrode side of the unit cell and was heated at 200° C. under reduced pressure while applying a load against the end seal. The entire periphery of the unit cell was thereby sealed by the end seal and the bonded top and bottom stainless steel foils. An all-solid-state lithium battery in a sealed form was thereby prepared. The oriented positive electrode plate of the resulting battery is not bonded to the current collecting plate. That is, the resulting battery includes a positive electrode current collector being in unbonded contact with the entire surface of the positive electrode plate on the side remote from the solid electrolyte layer, the unbonded contact being free from an adhesive.

### (3) Evaluation of Battery

Similarly, five all-solid-state lithium batteries were prepared and evaluated as in Example 1. The increase in resistance was 125%.

### Example 3 (Comparative)

In this example (comparative example), an all-solid-state lithium battery including a positive electrode plate containing reduced grain boundaries adhering to a current collecting plate was produced and was evaluated.

(1) Preparation of positive electrode plate containing reduced grain boundaries
(1a) Preparation of Co₃O₄ green sheet

A mixture composed of 100 parts by weight of Co₃O₄ feedstock powder (available from Seido Chemical Industry Co., Ltd.), 100 parts by weight of a dispersant (toluene:2-propanol=1:1), 10 parts by weight of a binder (polyvinyl butyral: Product No. BM-2, available from Sekisui Chemical Co., Ltd.), 4 parts by weight of a plasticizer (di(2-ethylhexyl)phthalate (DOP), available from Kurogane Kasei Co., Ltd.), and 2 parts by weight of a dispersant (Product Name: Leodol SP-030, available from Kao Corporation) was prepared. The Co₃O₄ feedstock powder had a volume D50 grain diameter of 0.3 μm. The resulting mixture was stirred under reduced pressure for defoaming and adjusted to a viscosity of 4000 cP to prepare a Co₃O₄ slurry. The viscosity was measured with an LVT viscometer available from Brookfield. The Co₃O₄ slurry prepared as described above was shaped into a sheet on a PET film by doctor blading to prepare a Co₃O₄ green sheet. The Co₃O₄ green sheet had a dry thickness of 55 μm.

### (1b) Preparation of Lithium Source

A mixture composed of 100 parts by weight of Li₂CO₃ feedstock powder (volume D50 grain diameter: 2.5 μm, available from Honjo Chemical Corporation), 5 parts by weight of a binder (polyvinyl butyral: Product No. BM-2, available from Sekisui Chemical Co., Ltd.), 2 parts by weight of a plasticizer (di(2-ethylhexyl)phthalate (DOP), available from Kurogane Kasei Co., Ltd.), and 2 parts by weight of a dispersant (Product Name: Leodol SP-030, available from Kao Corporation) was prepared. The prepared mixture was stirred under reduced pressure for defoaming and adjusted to a viscosity of 4000 cP to prepare a Li₂CO₃ slurry. The viscosity was measured with an LVT viscometer available from Brookfield. The Li₂CO₃ slurry prepared as described above was formed into a green Li₂CO₃ sheet on a PET film by doctor blading. The green Li₂CO₃ sheet had a dry thickness of 55 μm.

(1c) Step of Firing Co₃O₄ Green Sheet (First Firing Step)

The Co₃O₄ green sheet was separated from the PET film and cut into a 50-mm square with a cutter. The cut sheet was placed on the center of a zirconia setter (size: 90 mm square, height: 1 mm), and another zirconia setter was also placed on the Co₃O₄ green sheet. The Co₃O₄ green sheet disposed between the zirconia setters was placed in a 120-mm square alumina sheath (available from Nikkato Corporation). In this step, the alumina sheath was not sealed, and a lid was put on the sheath with a gap of 0.5 mm. Subsequently, the green sheet was heated up to 800° C. at a heating rate of 200° C./h and was fired for 5 hours to form a fired Co₃O₄ product. The fired Co₃O₄ product was then cooled to room temperature and was taken out from the alumina sheath.

### (1d) Step of Synthesizing Lithium Complex Oxide (Second Firing Step)

The fired Co₃O₄ product prepared in the first firing step was disposed between two green Li₂CO₃ sheets. The molar ratio of the Li contained in the green Li₂CO₃ sheet to the Co contained in the fired Co₃O₄ product was adjusted to 1.0. The fired Co₃O₄ product disposed between two green Li₂CO₃ sheets was disposed between zirconia setters and was placed in a 120-mm square alumina sheath (available from Nikkato Corporation). In this step, the alumina sheath was not sealed, and a lid was put on the sheath with a gap of 0.5 mm. Subsequently, the fired Co₃O₄ product was heated up to 800° C. at a heating rate of 200° C./h and was fired for 5 hours to synthesize a LiCoO₂ sintered body composed of bonded multiple primary grains composed of LiCoO₂. The LiCoO₂ sintered body was then cooled to room temperature and was taken out from the alumina sheath.

### (1e) Step of Coarsening Primary Grains (Third Firing Step)

The LiCoO₂ sintered body prepared in the second firing step was disposed between other green Li₂CO₃ sheets and was then placed in the alumina sheath again. The molar ratio of the Li contained in the green Li₂CO₃ sheet to the Co contained in the LiCoO₂ sintered body was adjusted to 2.50. Subsequently, the LiCoO₂ sintered body was heated up to 900° C. at a heating rate of 200° C./h and was fired for 5 hours to form a sintered lithium cobaltate plate having a thickness of 50 μm, including coarsened primary grains, and having five or less grain boundaries in the thickness direction. The bulk density of the resulting sintered plate was measured by the Archimedes method and was divided by the true density 5.05 g/cm³ of lithium cobaltate to calculate the density. The density of the sintered plate was 96%.

### (2) Production and Evaluation of All-Solid-State Lithium Battery

An all-solid-state lithium battery was produced using the resulting sintered plate and was evaluated as in Example 1. The increase in resistance was 165%.

### Example 4

In this example, an all-solid-state lithium battery including an oriented positive electrode plate in a state not bonded to a current collecting plate was produced and was evaluated.

An all-solid-state lithium battery was produced as in Example 2 using a positive electrode plate prepared as in Example 3. The resulting battery includes a positive electrode current collector being in unbonded contact with the entire surface of the positive electrode plate on the side opposite to the solid electrolyte layer, the unbonded contact being free from an adhesive. The battery was evaluated as in Example 1, and the increase in resistance was 115%.

What is claimed is:

1. An all-solid-state lithium battery comprising:
a self-supporting positive electrode plate composed of a sintered body containing a plurality of crystal grains composed of a positive-electrode active material, the positive electrode plate having a thickness of 20 μm or more;
a solid electrolyte layer composed of a lithium-ion conductive material disposed on a first side of the positive electrode plate;
a lithium-containing negative electrode layer disposed on the solid electrolyte layer; and
a positive electrode current collector composed of metal foil having a thickness of 5 μm or more and 30 μm or less, the positive electrode current collector being in unbound contact with the entire surface of a second side of the positive electrode plate remote from the solid electrolyte layer, the unbound contact being free from an adhesive.

2. The all-solid-state lithium battery according to claim 1, wherein the crystal grains are lithium cobaltate crystal grains.

3. The all-solid-state lithium battery according to claim 1, wherein the sintered body has a density of 90% or more.

4. The all-solid-state lithium battery according to claim 1, wherein the positive electrode plate further comprises an electrically conductive film having a thickness of 0.01 μm or more and less than 5 μm on the second side remote from the solid electrolyte layer.

5. The all-solid-state lithium battery according to claim 4, wherein the electrically conductive film is composed of a metal and/or carbon.

6. The all-solid-state lithium battery according to claim 1, wherein the positive electrode current collector further includes a carbon film on the first side adjacent to the solid electrolyte layer.

7. The all-solid-state lithium battery according to claim 1, wherein the positive electrode current collector is pressed against the positive electrode plate.

8. The all-solid-state lithium battery according to claim 7, wherein the pressing force of the positive electrode current collector against the positive electrode plate is generated by a difference in pressure between inside and outside of the positive electrode current collector.

9. The all-solid-state lithium battery according to claim 1, wherein a stack including the positive electrode plate, the solid electrolyte layer, and the negative electrode layer is packaged or sealed with a cladding, the positive electrode current collector constitutes a part of the cladding, and an accommodation space of the stack packaged or sealed with the cladding is under reduced pressure.

10. The all-solid-state lithium battery according to claim 1, wherein the positive electrode plate is an oriented positive electrode plate composed of an oriented sintered body containing a plurality of oriented crystal grains.

11. The all-solid-state lithium battery according to claim 10, wherein the oriented positive electrode plate has a thickness of 20 to 100 μm.

12. The all-solid-state lithium battery according to claim 10, wherein the crystal grains are lithium cobaltate crystal grains, and at least one of the (104) plane and (101) plane of lithium cobaltate in the oriented positive electrode plate is oriented in parallel to the plate surface of the oriented positive electrode plate.

13. The all-solid-state lithium battery according to claim 1, wherein the positive electrode plate includes six or less primary grains, on average, of the crystal grains residing in the thickness direction vertical to the plate surface.

14. The all-solid-state lithium battery according to claim 13, wherein the positive electrode plate has a thickness of 20 to 200 μm.

15. The all-solid-state lithium battery according to claim 1, wherein the lithium-ion conductive material constituting the solid electrolyte layer is a garnet ceramic material, a nitride ceramic material, a perovskite ceramic material, a phosphate ceramic material, a sulfide ceramic material, or a polymer material.

16. The all-solid-state lithium battery according to claim 1, wherein the lithium-ion conductive material constituting the solid electrolyte layer is a Li—La—Zr—O ceramic material and/or a lithium phosphate oxynitride (LiPON) ceramic material.

17. The all-solid-state lithium battery according to claim 1, further comprising an intermediate layer containing a metal alloyable with lithium on a surface of the solid electrolyte layer, the surface being adjacent to the negative electrode.
